(19) United States
(12) Patent Application Publication
(10) Pub. No.: US 2025/0053163 A1
(43) Pub. Date: Feb. 13, 2025

(54) Module for Sequentially Acquiring Data with Integrated AI Evaluation

(71) Applicant: Siemens Aktiengesellschaft, Muenchen (DE)

(72) Inventors: Gino GABRIEL, Chemnitz (DE); Max Andre MAUERSBERGER, Neukirchen/Erzgebirge (DE)

(21) Appl. No.: 18/795,745

(22) Filed: Aug. 6, 2024

(30) Foreign Application Priority Data
Aug. 7, 2023 (EP) 23190070

(51) Int. Cl. G05B 23/02

(52) U.S. Cl. CPC G05B 23/0213

(57) ABSTRACT

A module structured for sequential data acquisition with integrated AI evaluation includes a measuring unit for acquiring measured values from a test object via a sensor, an AI microcontroller, a data memory and an operating system module, wherein the measuring unit accepts a measuring instruction, performs a number of the measurements one after the other and acquires a series of measurements in accordance with a specified type of measurement, where the AI microcontroller, starting with a first series of measurements, retrieves these cyclically from the measuring unit and stores them in an array, applies the AI algorithm to the measured values of the first series of measurements and outputs the result via the operating system module over a backplane bus and, after evaluation of the first series of measurements, evaluates a further series of measurements from the array with an AI algorithm.

### BACKGROUND OF THE INVENTION

### 1. Field of the Invention

The invention relates to a hardware module configured for to sequentially acquired data with integrated AI evaluation comprising a measuring unit configured to acquire measured values from a test object via a sensor, an AI microcontroller configured to acquire and process an AI algorithm, a data memory, an operating system module, where the hardware module is further configured for a modular structure in an automation system to forward data to a higher-level unit via a backplane bus.

### 2. Description of the Related Art

Artificial Intelligence (AI) technology is becoming ever more reliable and applications are being employed ever more often in industrial systems. Consequently, there is a need for industrial AI equipment. Conventional automation devices such as programmable logic controllers (PLCs) do not have the computing power required for AI technology. Cloud-based AI solutions are available, but cannot easily be implemented for shopfloor solutions, i.e., the results of a cloud-based AI solution may not be readily available on the shopfloor.

The trend in automation systems in the wake of ongoing digitalization is increasingly in the direction of larger volumes of data. One cause of this increase is the integration of procedures intended to monitor and safeguard the quality of the products in the process. Impedance spectroscopy is a measurement procedure enabling physical phenomena to be described that cannot otherwise be represented using a simple coherent mathematical model. However, interpreting the resulting large volume of data is no minor matter, for which reason an experience-based evaluation using artificial intelligence offers a solution. Currently, the trend is to perform AI-based operations in the cloud. To do this, the data must be transferred from the source to the cloud via a backplane bus, the CPU, and/or the higher-level control system. The data is evaluated in the cloud and is returned in the same manner. The resulting workload for the backplane bus is enormous, because it is not designed for such a volume of data. Relocating the analysis to the local periphery closest to the data source reduces the amount of communication to a minimum and also ensures data sovereignty for the user.

### SUMMARY OF THE INVENTION

In view of the foregoing, it is therefore an object of the present invention to provide a hardware module, in particular for automation technology, which allows users to evaluate measured data acquired for their process-specific requirements in situ with the help of AI networks or neural networks, without using a cloud service.

This and other objects and advantages are achieved in according with the invention by a hardware module in which a measuring unit is configured to accept a measuring instruction containing at least the following measurement parameters: a type of measurement, a number of desired measurements, which is further configured to perform the number of measurements one after the other in accordance with the specified type of measurement and to acquire a series of measurements, where the AI microcontroller is configured, starting with a first series of measurements, to retrieve these cyclically from the measuring unit and to store them in an array. The AI microcontroller is further configured to apply the AI algorithm to the measured values of the first series of measurements and to output the results via the operating system module over the backplane bus and is further configured, after evaluation of the first series of measurements, to evaluate a further series of measurements from the array with the AI algorithm.

In accordance with the invention, a freely programmable measuring unit and a freely programmable AI microcontroller, i.e., the AI evaluation, are now integrated into a module, in particular a peripheral module for a modular structure of, for example, local peripheral modules. Users can now parameterize their measuring unit, for example, for a structure-borne sound measurement or a vibration measurement or impedance spectroscopy, and to supply the acquired results directly for an evaluation via AI algorithms.

All data can now be preprocessed and, to reduce the data load, it is possible to transmit just the result, e.g., a classification obtained from the series of measurements. Using the module, in particular in automation technology, a realtime capability of the main controller can be guaranteed, because by reducing the load on the backplate bus the load on the main controller is also reduced, therefore resulting overall in a shorter latency period.

A further advantage of such a module is the adaptability of the module to a wide variety of applications and this in turn results in a simplification for a commissioning engineer. Standardized hardware now exists that can solve manufacturing tasks with appropriate parameterization and adapted neural networks.

In accordance with the invention, neural networks, in other words, artificial neural networks, map neural structures with learned knowledge. From the field of artificial intelligence there is a “knowledge discovery in database” method, often also referred to as data mining. From this, data mining is derived the general claim of discovering unknown correlations from usually very large datasets. In this case, the algorithms used are operated differently, i.e., without specifying explicit result expectations, to analyze the datasets. With supervised learning methods, such as classification, a specific result is expected. Deviations can be trained on the model at the same time so that it reacts more robustly to strong fluctuations. How it reacts to fluctuations depends on the algorithm, the parameters thereof and the data with which it was trained. In particular, materials used in automated production are subject to production-related or batch-related fluctuations.

In the module, the measuring unit and the AI microcontroller are advantageously configured to be parameterized by an engineering station for the respective type of measurement and are then parameterized for a structure-borne sound measurement, a vibration measurement or an impedance measurement.

Especially for a parameterization for an impedance measurement, the measuring unit is then configured as an impedance measurement unit and can thus use an electrical test signal to acquire a series of measurements or an impedance spectrum dependent on a frequency and/or an amplitude of the test signal from the test object via the sensor. Here, the impedance measurement unit is configured to start, via the measuring instruction, with a start frequency, and with a stop frequency to perform the measurement a last time to acquire a number of the desired measurements.

The advantage of this is that the frequencies are distributed evenly over the entire measurement frequency band. In order to increase the measurement range in the case of a ratiometric measurement, four calibration resistances are optionally switched in by a multiplexer impedance measurement unit. On conclusion of a measurement with a particular frequency the next frequency is calculated in accordance with the following formula. This is then also implemented in the measuring unit or in the microcontroller in accordance with the parameterization.

$${f}_{neu} = {10}^{k \cdot \frac{log ( \frac{{f}_{stop}}{{f}_{start}} )}{K - 1}}$$

$$neu = new$$

Where:
K—Total number of measurements
k—Index of the current measurement

It is also implemented in the measuring unit or in the microcontroller that a multiplexer is correspondingly controlled, where the impedance measurement unit or the AI microcontroller is configured to, starting with a value of a calibration resistance, perform the measurement and to evaluate the measured data, and to compare whether the measured impedance is less than 80% of the calibration resistance. If the measured impedance is less than 80% of the calibration resistance, then the multiplexer will switch in the next smallest calibration resistance.

The same signal can now similarly be applied to the unknown testpiece and a known reference resistance. In this resistance measurement with a reference resistance, the unknown resistance, i.e., the impedance, is determined with the help of the voltage drops across the resistance to be measured and the reference resistance with a voltmeter. The reference resistance is known. Accordingly, the unknown resistance can be determined from the ratio of the voltages multiplied by the reference resistance. A resulting ratio equation can be represented in C code and is used to calculate the unknown impedance of the testpiece. Due to this measurement procedure, the accuracy of the measurement suffers extremely if the difference between the calibration resistance and the impedance of the testpiece is too large. For this reason, the measured data is evaluated after each frequency of the measurement signal. Here, a comparison is made to determine whether the measured impedance is less than 80% of the reference resistance. If the measured impedance is less than 80% of the reference resistance, then the microcontroller will switch in the next smallest reference resistance via a multiplexer and the measurement is repeated.

Particularly in the case of the impedance measurement, a paradoxical effect has arisen with respect to accuracy, because if the AI microcontroller is configured to apply the AI algorithm to an imaginary part of the measured values of the series of measurements, then it is possible to achieve particularly accurate results or classifications with the AI algorithm. The measuring unit can be parameterized so that it measures the physical variables: amplitude, phase, real part, imaginary part and loss factor. Thus, each series of measurements can contain a maximum of five variables or only one or any combination.

To make an evaluation in the hardware module more robust against unknown data, the AI microcontroller is configured to use a residual neural network in the AI algorithm for the evaluation. A residual network with a total of 12 convolutional layers is preferably employed. Although typical residual neural network architectures have a depth of 18, 34, 50, 101 and 152 convolutional layers, it has been found that 12 layers are sufficient for the given application, because the model converges within a few epochs.

In order to advantageously employ the hardware module in an automation network, the operating system module is configured such that the AI microcontroller and the measuring unit can be parameterized or programmed via the backplane bus.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing shows an exemplary embodiment of the invention, in which:

FIG. 1 shows a hardware module configured to sequentially acquire data with integrated AI evaluation;

FIG. 2 shows an array for series of measurements in accordance with the invention;

FIG. 3 shows a general structure of an AI microcontroller; and

FIG. 4 shows a possible sequence for an initialization and a measurement sequence by the AI controller and the measuring unit in accordance with the invention.

### DETAILED DESCRIPTION OF THE EXEMPLARY EMBODIMENTS

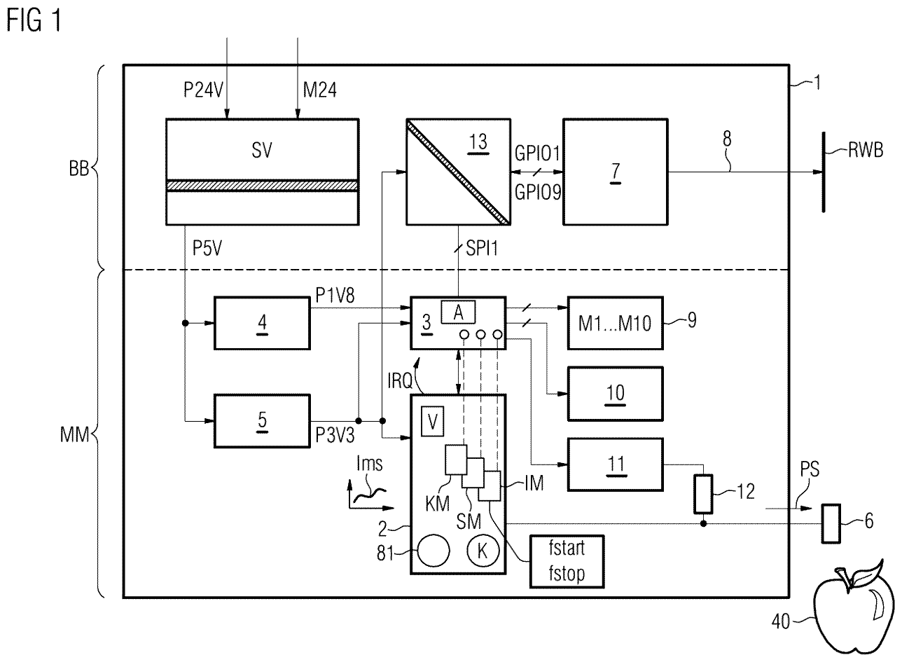

In accordance with FIG. 1, a hardware module 1 for sequential data acquisition with integrated AI evaluation is shown. The hardware module 1 is divided into a baseboard BB and a measurement module MM. The base module BM has a power supply unit SV, which is supplied externally with 24 Volt P24V, and a ground connection M24. Furthermore, the power supply unit SV has a voltage transformer that emits a constant voltage of 5 Volt. For general control and coordination tasks relating to the baseboard BB and the measurement module MM, the baseboard BB has an operating system module 7. The operating system module 7 is firstly connected to a backplane bus terminal 8 and secondly to an isolation module 13 for the galvanic isolation of the signals via internal data communication lines, for example, GPIO1 to GPIO9 (General Purpose Input Output). The isolation module 13 is in this case formed as a magnet coupler. The backplane bus terminal 8 of the operating system module 7 is accordingly connected to a backplane bus RWB. In a modularly structured automation system, the backplane bus RWB serves to acquire further modules, input/output assemblies, technology assemblies, etc. In addition, the backplane bus RWB connects the modules in question to a higher-level programmable logic controller.

The measurement module MM integrated into the module 1 has firstly a supply voltage connection P5V and secondly a data link SPI to the base module. A first voltage regulator 4 on the measurement module MM supplies a constant voltage of 1.8 Volt for the subsequent modules. A second voltage regulator 5 supplies a constant voltage of 3.3 Volt for the subsequent modules.

At the heart of the measurement module MM is a freely programmable AI controller 3 and a likewise freely programmable measuring unit 2. The AI microcontroller 3 and the measuring unit 2 are likewise connected to one another via internal data lines, i.e., Serial Peripheral Interface (SPI). The measuring unit 2 is configured to acquire measured values from a test object 40 via a sensor 6. The AI microcontroller 3 is configured to acquire and store an AI algorithm. A data memory 9 can be used to buffer series of measurements. The measuring unit 2 is configured to accept a measuring instruction V containing at least the following measurement parameters. A type KM, SM, IM of measurement, where KM corresponds to a structure-borne sound measurement, SM corresponds to a vibration measurement, and IM corresponds to an impedance measurement in accordance with the principle of impedance spectroscopy. This means that, via the predefinable measuring instruction V, the measuring unit 2 can be freely programmed for particular applications. In addition, the measuring unit 2 is notified of a number K of measurements to be performed one after the other. The AI microcontroller 3 is in this case configured to, starting with a first series of measurements M1, retrieve these cyclically from the measuring unit 2 and to store them in an array A. The dashed lines between the AI microcontroller 3 and the measuring unit 2 mean that when programming, for example, for the type KM, which corresponds to a structure-borne sound measurement, the AI microcontroller 3 and the measuring unit 2 are programmed or parameterized jointly with one another, in order to collaborate with the corresponding interaction with respect to the subsequent neural networks during the measurement and evaluation.

The AI microcontroller 3 is configured to apply the AI algorithm to the measured values of the first series of measurements M1 and as should be understood to the further series of measurements, and to output the result via the operating system module 7 over the backplane bus RWB. A particular advantage of this configuration is that the AI evaluation is performed directly after the acquisition of a series of measurements into the AI microcontroller 3. This enables fast, memory-saving sequential processing in situ. Furthermore, the AI microcontroller 3 is configured to, after the evaluation of the first series of measurements M1, evaluate a further series of measurements M2, . . . , M10 from the array A with the AI algorithm.

It is advantageous that the AI microcontroller 3 is configured to be parameterized via an engineering station for the respective type KM,SM,IM of measurement and thus is parameterized for a structure-borne sound measurement, a vibration measurement or an impedance measurement.

If the AI microcontroller 3 and the measuring unit 2 are parameterized for an impedance measurement, then the measuring unit 2 is configured to use an electrical test signal PS, which is also generated by the measuring unit, to acquire a series of measurements or an impedance spectrum IMS dependent on a frequency and/or an amplitude of the test signal PS from the test object 40 via the sensor 6. The measuring unit 2 or the now thus parameterized impedance measurement unit is configured to, via the measuring instruction V, start with a start frequency fstart and to stop with a stop frequency fstop and thereby to acquire a number K of the desired measurement.

A special feature of the parameterization of the measuring unit 2 is that the impedance measurement unit and/or also the AI microcontroller 3 are configured to, starting with a value of a calibration resistance 12 or Rcal, perform the measurement and to evaluate the measured data, and to compare whether the measured impedance is less than 80% of the calibration resistance. If the measured impedance is less than 80% of the calibration resistance, then the multiplexer 11 will switch in the next smallest calibration resistance.

In order, starting from the start frequency fstart to a stop frequency fstop, to achieve corresponding frequency steps the impedance measurement unit 2 also contains a frequency calculation formula 81, which specifies logarithmic frequency steps; a linear specification would also be possible.

$${f}_{neu} = {10}^{k \cdot \frac{log ( \frac{{f}_{stop}}{{f}_{start}} )}{K - 1}}$$

$$neu = new$$

Furthermore, the measurement module MM has a memory card 10 for additional programs or the acquisition of measurement files. Alternatively, the array A for the series of measurements M1, . . . ,M10 can also be stored in an additional data memory 9.

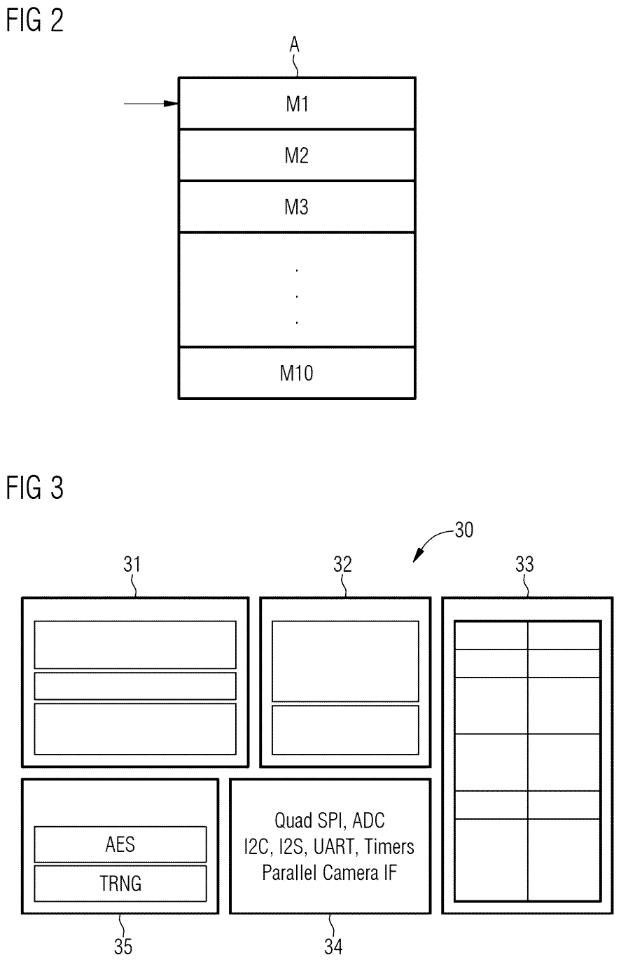

For clarification, FIG. 2 once again shows the array A in which a first series of measurements M1, a second series of measurements M2 up to a tenth series of measurements M10 are stored sequentially one after the other. For a final evaluation by the AI microcontroller 3, the array A can now be deftly processed sequentially one after the other and can be evaluated, measurement series by measurement series, by the AI algorithm. So that a new series of measurements can always be transferred from the measuring unit 2 to the AI microcontroller 3 and thus to the array A, the measuring unit 2 informs the AI microcontroller 3 via an interrupt IRQ, which then retrieves the series of measurements to be evaluated from the measuring unit.

FIG. 3 shows a general structure of the AI microcontroller 3. As an example, an assembled chip 30 is shown. An on-chip system memory 32 with 512 KB Flash and 128 KB SRAM are available on the chip 30. Communication interfaces 34, such as a Quad SPI, an 12S or a camera interface PCIF, are likewise available. For a low energy consumption of the chip 31, it has an ARM Cortex M4F-M4 with a CPU for a system controller and a Risk-V processor for customer-specific applications. To expedite the processing of an AI algorithm, the chip 30 likewise has an accelerator 33. The accelerator 33 is also referred to as a CNN accelerator and can operate multiple processors in parallel; it can also acquire a plurality of layers 32-64³ for the AI evaluation; it can acquire a weighting; it has a maximum number of input and output variables, etc.

The primary component of the AI microcontroller 3 is therefore the CNN accelerator. This has 64 processors that are divided into four quadrants of 16 processors each. Each processor is connected to a separate weight memory instance; four processors share a data memory instance. Overall, each quadrant has its own data, weight and bias memory. The data memory for all quadrants can be represented similarly as in FIG. 3. All input data to be processed in a neural network must be stored in the respective data memory instance of the corresponding processors.

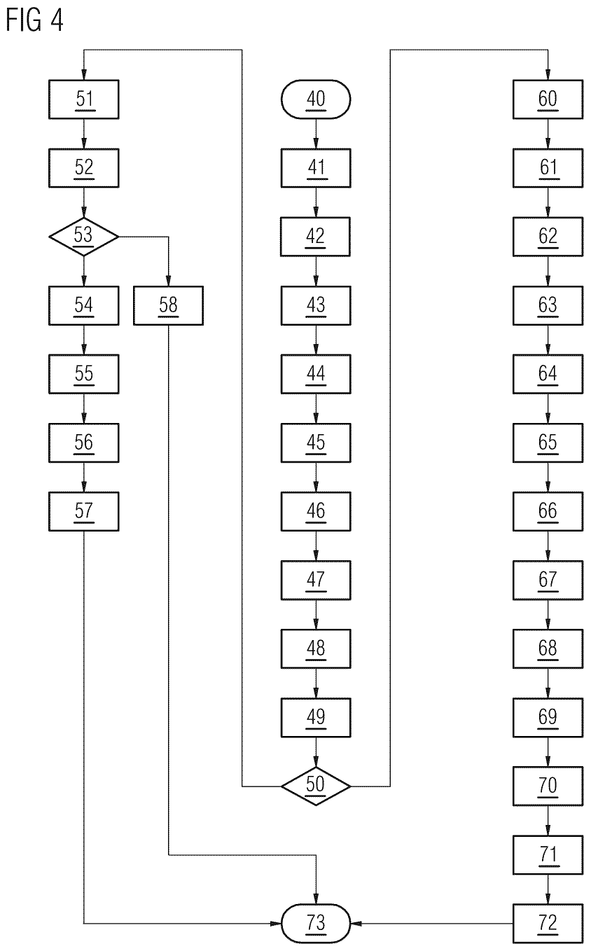

FIG. 4 shows a program operation plan for a possible parameterization and performance of a measurement of the AI microcontroller 3 and the measuring unit 2. Commencing with the start 40, the AI microcontroller 3 is first programmed in an initialization step 41. In a further initialization step 42 the measuring unit 2 is initialized. In a third initialization step 43, the largest resistance is first set at the multiplexer 11 in the example of an impedance measurement. Then, the AI microcontroller 3 is as it were powered up and in a fourth step 44 the CNN accelerator is switched on. In a fifth step 45, the CNN accelerator is initialized. After this, in a sixth step 46 the weights are loaded into the weight memory of the CNN accelerator. The biases are also loaded into the bias memory in a seventh step 47. Now, in an eighth step 48, the CNN accelerator is configured for a given model. The AI microcontroller 3 is now ready to process input data and, in a ninth step 49, input data is loaded.

A non-answer test 50 must now be used to decide whether to start with a sample dataset or with the loading of a real series of measurements. In the case of the sample dataset, a sample dataset is loaded with the execution load of the sample dataset 51 and an evaluation of the sample dataset 52 can be started. Based on the sample dataset, a check 53 is performed to determine whether the processing and the evaluation are proceeding correctly. If the processing and the evaluation are proceeding correctly, then an inference output 54 is loaded and an output probability is calculated in a further step 55. The CNN accelerator is then switched off with 56 and a classification result is displayed 57.

If alternatively a real measurement series array is loaded, then it is loaded with the loading step 60, following which the inference is started 61 and in a check 62 the inference output is compared to given results. Should this be successful, the inference output 63 is loaded and in turn an output probability 64 is calculated. The CNN accelerator is then switched off 65 and the classification results 66 are displayed. The measuring unit 2 can now be initialized and can once again write measurement results to the array A with step 68. A scaling 69 to an array A from −128 to +127 is performed. The class can then again be classified into the AI microcontroller 3 with the step Determination 70. It is now important that in step 71 the results are written to a buffer and thus the operating system module 7 can read them out in a readout step 72 and make them available on the backplane bus RWB. A measurement operation concludes with the end 73.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements that perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A hardware module for sequentially acquiring data with integrated AI evaluation, the hardware module comprising:
a measuring unit configured to acquire measured values from a test object via a sensor;
an AI microcontroller configured to acquire and process an AI algorithm;
a data memory;
an operating system module;
wherein the hardware module is configured for a modular structure in an automation system to forward data to a higher-level unit via a backplane bus;
wherein the measuring unit is further configured to accept a measuring instruction containing at least the following measurement parameters (i) a type of measurement and (ii) a number of desired measurements;
wherein the hardware module is further configured in accordance with a specified type of measurement to perform a number of the measurements one after another and to acquire a series of measurements;
wherein the AI microcontroller is further configured to, starting with a first series of measurements, cyclically retrieve the first series of measurements from the measuring unit and to store the retrieved first series of measurements in an array; and
wherein the AI microcontroller is further configured to apply the AI algorithm to the measured values of the first series of measurements and to output a via the operating system module over the backplane bus and is further configured, after evaluation of the first series of measurements, to evaluate a further series of measurements from the array with the AI algorithm.

2. The module as claimed in claim 1, wherein the measuring unit and the AI microcontroller are further configured to be parameterized via an engineering station for the respective type of measurement and are parameterized for a structure-borne sound measurement, a vibration measurement or an impedance measurement.

3. The module as claimed in claim 1, wherein in a parameterization for an impedance measurement the measuring unit is configured as an impedance measurement unit which utilizes an electrical test signal to acquire a series of measurements or an impedance spectrum dependent on at least one of a frequency and an amplitude of the test signal from the test object via the sensor, the impedance measurement unit being further configured to start, via the measuring instruction, with a start frequency and to stop with a stop frequency such that a number the desired measurements is acquired.

4. The module as claimed in claim 1, wherein in a parameterization for an impedance measurement the measuring unit is configured as an impedance measurement unit which utilizes an electrical test signal to acquire a series of measurements or an impedance spectrum dependent on at least one of a frequency and an amplitude of the test signal from the test object via the sensor, the impedance measurement unit being further configured to start, via the measuring instruction, with a start frequency and to stop with a stop frequency such that a number the desired measurements is acquired.

5. The module as claimed in claim 3, further comprising:
a multiplexer;
wherein the impedance measurement unit or the AI microcontroller is further configured to, starting with a value of a calibration resistance, perform the measurement and to evaluate the measured data, and to compare whether the measured impedance is less than 80% of the calibration resistance; and
wherein the multiplexer switches in the next smallest calibration resistance if the measured impedance is less than 80% of the calibration resistance.

6. The module as claimed in claim 3, wherein the AI microcontroller is further configured to apply the AI algorithm to an imaginary part of the measured values of the series of measurements.

7. The module as claimed in claim 5, wherein the AI microcontroller is further configured to apply the AI algorithm to an imaginary part of the measured values of the series of measurements.

8. The module as claimed in claim 1, wherein the AI microcontroller is further configured to utilize a residual neural network to evaluate the AI algorithm.

9. The module as claimed in claim 1, wherein the operating system module is configured such that the AI microcontroller and the measuring unit are parameterizable or programmable via the backplane bus.
